(19) United States
(12) Patent Application Publication
(10) Pub. No.: US 2026/0291320 A1
(43) Pub. Date: Sep. 24, 2026

(54) METHOD FOR PRODUCING AN AIR-GAP SLEEVE FOR AN ELECTRICAL MACHINE

(71) Applicant: ZF FRIEDRICHSHAFEN AG, Friedrichshafen (DE)

(72) Inventors: Konrad BUETTNER, Gädheim (DE); Matthias REUß, Werneck (DE); Ignacio LOBO CASANOVA, Markdorf (DE)

(21) Appl. No.: 19/475,492

(22) PCT Filed: Apr. 15, 2024
(86) PCT No.: PCT/EP2024/060106

§ 371 Date: Oct. 15, 2025

(30) Foreign Application Priority Data
Apr. 18, 2023 (DE) 10 2023 203 478.6

(51) Int. Cl. H02K 5/128; H02K 15/123; H02K 15/142

(52) U.S. Cl. CPC H02K 5/128; H02K 15/123; H02K 15/142; H02K 2201/03

(57) ABSTRACT

A method for producing an air gap can for an electric machine, which air gap can is arrangeable or is arranged in a base body opening of a stator base body of the electric machine. The air gap can is formed to separate a stator space and a rotor space of the electric machine when mounted in the base body opening. At least one structural layer comprising a plurality of structural elements, in particular a layup or a woven fabric, is provided, the structural elements of which are connected to at least one connection element, in particular a sewing thread. The at least one structural layer is arranged on a core and is impregnated with a matrix material and cured. At least two structural elements of at least one structural layer are connected with a connection element formed as a multifilament.

### CROSS REFERENCE TO RELATED APPLICATIONS

This is a U.S. national stage of Application No. PCT/EP2024/060106 filed Apr. 15, 2024. Priority is claimed on German Patent Application No. DE 10 2023 203 478.6 filed Apr. 18, 2023, the contents of which are incorporated herein by reference.

### BACKGROUND OF THE INVENTION

### 1. Field of the Invention

The disclosure is directed to a method for producing an air gap can for an electric machine, particularly an electric machine of a motor vehicle, which air gap can is arrangeable or arranged in a base body opening of a stator base body of the electric machine. When mounted in the base body opening, the air gap can is formed to separate a stator space and a rotor space of the electric machine. At least one structural layer comprising a plurality of structural elements, in particular a layup or a woven fabric, is provided, the structural elements of which are connected to at least one connection element, in particular a sewing thread. The at least one structural layer is arranged on a core and is impregnated with a matrix material and cured.

### 2. Description of the Related Art

Methods for producing air gap cans for electric machines, for example, electric machines in motor vehicles, are generally known from the prior art. Such air gap cans are arranged in the electric machine in a base body opening of a stator base body to spatially separate a rotor space of the electric machine in which the rotor is rotatably mounted from a stator space in which the stator base body is arranged. In particular, the separation ensures that different fluids, for example, oil, in the stator space and in the rotor space cannot intermix and in particular that a liquid from one of the spaces cannot penetrate into the other space.

One example of a method for producing such air gap cans is what is known as an “RTM process” (resin transfer molding), in which one or more structural layers, for example, layers of a woven fabric or a layup, are impregnated in a mold with a matrix material, in particular a resin, which resin is subsequently cured under temperature control. The above-described structural layers are placed on a core which ultimately defines the inner radius or inner surface of the air gap can. In order that the structural layers may be handled during the process, they are connected to one another by connection elements, in particular sewing threads.

Sewing threads of the kind mentioned above may be produced in particular from a thermoplastic material. As a result, the matrix material behaves differently in the area of the sewing threads than in the area of the structural elements of the structural layer. Specifically, owing, for example, to insufficient adhesion, shrinkage, or differing thermal expansion of the sewing threads, the connection between the matrix material and sewing threads can be weakened or completely lost, which can lead to the formation of cracks, channels or channel sections along the sewing threads. Since the sewing threads extend through the structural layer at different points, it is possible, at worst, that the individual channels formed by the detachment between the matrix material and the sewing thread may join so that a conductive connection between the exterior of the air gap can and the interior of the air gap can cannot be reliably prevented.

However, it is not possible to dispense with the connection elements and sewing threads described above due to the required handling of the structural layers, since the individual structural elements of the structural layers are connected to one another by the sewing threads and only in this way is it possible to handle them as a “layer,” in particular to apply the structural layer to the core by a rolling or winding process.

### SUMMARY OF THE INVENTION

It is the object of one aspect of the invention to provide a method for producing an air gap can for an electric machine which is improved over the prior art and in which weakening of the air gap can due to connection elements is prevented.

As was described, the disclosure is directed to a method for producing an air gap can for an electric machine, in particular an electric machine of a motor vehicle. The air gap can itself is formed from at least one structural layer or a plurality of structural layers which are applied to a core, for example, and impregnated with a matrix material. The matrix material can subsequently be cured, to form the air gap can. The air gap can may then be removed from the above-described core and inserted into an opening in the base body of a stator of the electric machine or arranged therein to form an assembly for the electric machine.

In the assembled state in which the air gap can is arranged in the base body opening, the air gap can separates the stator space from the rotor space of the electric machine. In order to be able to handle the structural layers in the above-described process, in particular so as to be able to place the individual structural elements in the form of the structural layer on a core, it is necessary to connect them to one another, namely, with the above-described connection element or the plurality of connection elements, in particular sewing threads.

One aspect of the invention is based on the insight that at least two structural elements of at least one structural layer are connected with a connection element formed as a multifilament. The disadvantages of the sewing threads used as described above in relation to the prior art are overcome in particular in that a multifilament is used instead of a monofilament to form the connection elements. By “multifilament” is meant in particular connection elements or sewing threads that are formed of a plurality of individual threads or individual fibrous elements, i.e., the total cross section of the multifilament is formed from the individual cross sections of the individual fibrous elements or discrete fibrous elements.

Accordingly, the multifilament can be understood as a “bundle” of individual fibrous elements or discrete fibrous elements. This results in a number of advantages with respect to the problem described above with regard to the formation of channels. These advantages will be described in detail in the following. In particular, an appreciable reduction in the tendency to form channels is realized and, even if channels do form, the size and length of the individual channels can be appreciably reduced so that, in particular, no comparatively large channels extending parallel to the connection elements can form within the matrix material that could combine with one another and accordingly, in the worst case, result in a communication between the outside and the inside of the air gap can. Instead, no channels or cracks are formed or, if at all, are at most only small and do not communicate with one another.

The material of the multifilament is freely selectable in principle and, in general, any fibrous elements or materials suitable for connecting the structural elements in the structural layer can be used. For example, the individual fibrous elements of the multifilament can comprise or have a thermoplastic. In addition or alternatively, individual fibrous elements of the multifilament may comprise glass fibers, aramid fibers, biofibers, or other fibers or have such a material.

In a further development of the method, it may be provided that a total cross section of the at least one connection element is formed from individual cross sections of the individual fibrous elements forming the connection element. As was described above, the connection element formed as multifilament has a plurality of individual fibrous elements which have, in each instance, a cross section or fiber cross section. Accordingly, the total cross section of the connection element is formed from the individual cross sections or fiber cross sections of the individual fibrous elements which are arranged as a “bundle” and accordingly form the connection element. In other words, instead of an individual, comparatively thicker connection element, a “bundle” of comparatively thinner individual fibrous elements can be formed which together provide a comparable diameter compared with the monofilament but individually have an appreciably smaller diameter.

For example, the total cross section of the connection element as multifilament can correspond to the diameter of a monofilament that is conventionally used, the individual cross sections of the individual fibrous elements being appreciably smaller and only corresponding to the total cross section when added together. As has been described, the effects occurring between the matrix material and the connection element are accordingly appreciably reduced, since the expansions of the individual fibrous elements are already appreciably smaller than those of a commonly used monofilament. As a further result, even if channel formation occurs, the channel in question is appreciably smaller in size, in particular has a smaller diameter and a shorter length, so that the weakening of the structural layer that results is appreciably less or possibly does not occur at all.

Further, in the method described above, it can be provided that receiving spaces for matrix material are formed between the individual fibrous elements of the at least one connection element. As has been described, the structural layer is applied to a core together with the connection elements that hold the structural elements of the structural layer together and is subsequently impregnated with matrix material. Accordingly, by forming the receiving spaces for the matrix material “inside of” the connection element, namely, between the individual fibrous elements, it is possible for the matrix material to also penetrate into the connection element instead of merely surrounding it outwardly.

This appreciably improves the connection between the matrix material and the connection element. Accordingly, when the connection element is seen as a bundle of individual fibrous elements, the matrix material can surround the individual fibrous elements so that matrix material can also penetrate into the intermediate spaces between the individual fibrous elements, which are also referred to as “receiving spaces.” In this way, every single individual fibrous element can be surrounded by the matrix material so as to appreciably increase the connection to the matrix material. As a result, the cross-sectional area surrounded by matrix material in the multifilament is appreciably larger and the matrix material is appreciably better distributed in relation to the connection element. If channel formation nevertheless occurs, it extends over an appreciably smaller area and possibly over an appreciably shorter length compared to a monofilament.

As has been described above, the at least one connection element is formed of a multifilament or comprises such a multifilament, i.e., a plurality of individual fibrous elements. In a further development of the method, it can be provided that the at least one connection element defines a longitudinal direction, and at least one individual fibrous element, in particular all of the individual fibrous elements, are arranged at least partially in an orientation deviating from the longitudinal direction. It is accordingly provided in the configuration that the connection element as a whole, i.e., the multifilament, determines a longitudinal direction, namely, along the longitudinal axis or longitudinal center axis of the multifilament.

The individual fibrous elements that form the connection element are also basically oriented along the longitudinal axis, but change their orientation due to their arrangement relative to the other individual fibrous elements. For example, the individual fibrous elements do not run in a straight line and parallel to the longitudinal axis, but rather in an orientation that varies along the longitudinal direction. Although it is also possible in principle to align the individual fibrous elements parallel to one another over the entire length of the connection element, it is possible in the present configuration that these individual fibrous elements have a defined braiding pattern or a random structure. For example, the individual fibrous elements can be intermingled, intertwined or twisted together to form the connection element and accordingly change their position over the length of the connection element relative to a longitudinal axis of the entire connection element.

As a result, the positions of the individual fibrous elements in a cross section in a first position along the length of the connection element change compared to the positions of the individual fibrous elements in the cross section in a second position along the length of the connection element. The positions of the individual fibrous elements can be viewed, for example, in relation to a center point of the cross section of the connection element and can change in an orderly or random manner to form an intermingling, twisting or intertwining and consequently deviate from a purely parallel orientation of the individual fibrous elements. This further ensures that even if cracks or channels form, such formation of channels or cracks can be blocked or halted. If the individual fibrous elements that are intermingled or intertwined with one another meet, the crack or channel can be stopped at this point and accordingly prevent the formation of a continuous channel. Further, an appreciably increased flow resistance is realized for a liquid in this area by the random or intertwined arrangement of the individual fibrous elements, especially compared to a purely parallel arrangement of the individual fibrous elements to one another or a continuous larger channel.

Further, in the method described, it can be provided that the at least one connection element is connected to the at least two structural elements by a defined type of weave, where the type of weave can stop a crack occurring in a matrix material along at least one individual fibrous element. Within the meaning of the present application, the term “type of weave”, as is typical in the art, refers to the manner in which the connection elements are arranged within the structural layer in order to connect the individual connection elements to one another. It can be ensured through the selected defined type of weave that the individual fibrous elements are arranged in such a way that cracks or channels forming along an individual fibrous element are interrupted as quickly as possible by another individual fibrous element which is oriented relative to the first-mentioned individual fibrous element.

As previously described, the defined type of weave which determines the connection between the connection element and the at least two structural elements can influence the tendency for cracks or channels to form. Within the meaning of the present application, “crack” or “channel” is generally understood to mean weakening of the connection between the connection element and the matrix material, for example, a detachment of the matrix material from the connection element. The terms are therefore interchangeable and the description is transferable in a corresponding manner.

In particular, it can be provided in the method that the at least one connection element is connected to the at least two structural elements by a chain weave or a tricot weave. In the chain weave embodiment, the connection element or elements forms, in each instance, a chain whose chain links or loops wrap around the structural elements, i.e., the reinforcing fibers in the structural layer. This forms a continuous connection element that surrounds the structural elements. In other words, one of the loops or one of the chain links can reach through the respective subsequent loop or the respective subsequent chain link. The individual loops and/or chain links can be connected to one another. In a tricot weave, a zigzag arrangement of the connection element can be achieved in particular. In both cases, the type of weave can reduce the tendency of cracks to form or can achieve a crack-stopping effect.

As has already been described referring to a previous embodiment, the individual fibrous elements can, in principle, be aligned or arranged in a desired manner within the at least one connection element and can also change their orientation and arrangement over the length of the connection element. In a further embodiment of the method, it can be provided that individual fibrous elements of the at least one connection element are twisted in circumferential direction. In other words, the connection element as such can be twisted around its longitudinal axis so that the individual fibrous elements forming the connection element are arranged to be twisted in circumferential direction. For example, the individual fibrous elements can form a helix around the longitudinal axis. Due to the twisted arrangement of the individual fibrous elements, undercuts for the matrix material, for example, a resin, are formed at the surface of the connection element so that the connection between the matrix material and the connection element is improved.

In addition to the method, the disclosure is directed to an air gap can for an electric machine, particularly produced by a previously described method, which air gap can is arrangeable or arranged in a base body opening of a stator base body of the electric machine and, in a state in which it is mounted in the base body opening, the air gap can is formed to separate a stator space and a rotor space of the electric machine, the air gap can having at least one structural layer comprising a plurality of structural elements, in particular a layup or a woven fabric, the structural elements of which are connected to at least one connection element, in particular a sewing thread, the at least one structural layer is impregnated with a matrix material and cured, and at least two structural elements of at least one structural layer are connected to a connection element formed as a multifilament.

The disclosure is further directed to an electric machine comprising a previously described air gap can. In addition, the disclosure is directed to a motor vehicle comprising such an electric machine and/or a previously described air gap can.

### BRIEF DESCRIPTION OF THE DRAWINGS

The invention is described in the following based on exemplary embodiments referring to the drawings. The drawings are schematic representations and show:

FIG. 1 is a schematic top view showing a structural layer of an air gap can;

FIG. 2 is a schematic sectional view in a first axial position of a connection element;

FIG. 3 is a schematic sectional view in a second axial position of a connection element; and

FIG. 4 is a schematic section of a connection element.

### DETAILED DESCRIPTION OF THE PRESENTLY PREFERRED EMBODIMENTS

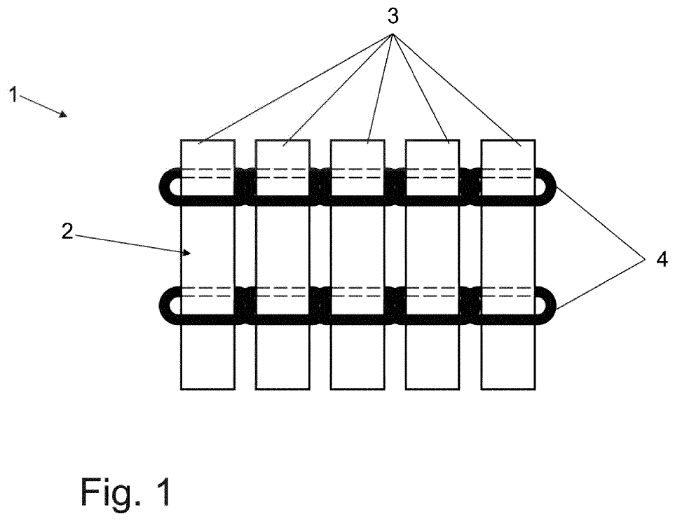

FIG. 1 shows a schematic section of an air gap can 1, particularly of a structural layer 2, which has, for example, a plurality of structural elements 3. The structural layer 2 may, for example, comprise a layer of determined fibrous elements, where the structural elements 3 can be understood as individual fibers, for example, glass fibers or aramid fibers. To enable reliable handling of the structural layer 2 during the process of producing the air gap can 1, the structural elements 3 are connected to one another by connection elements 4. The view shown in FIG. 1 is to be understood as purely exemplary, since the quantity of and arrangement of the structural elements 3 can be changed as desired; in particular, a plurality of structural elements 3 can also be connected to one another by connection elements 4, for example, in pairs or by groups, instead of the individual looping shown in FIG. 1.

FIG. 1 shows, purely by way of example, a chain weave in which the connection elements 4 form a chain of individual “chain links” or “loops” which are arranged around individual or multiple structural elements 3 and fix the latter in position within the structural layer 2. This makes it possible to handle the structural layer 2 during the process, for example, to place it on a core, not shown in detail, and to impregnate it subsequently with a matrix material. The connection elements 4, which may also be referred to as “sewing threads,” hold the individual structural elements 3 in their position and hold the structural layer 2 together so that the structural layer 2 can be handled as a layer, in particular without disintegrating. Instead of the chain weave shown, any other type of weave can also be realized, for example, a tricot weave.

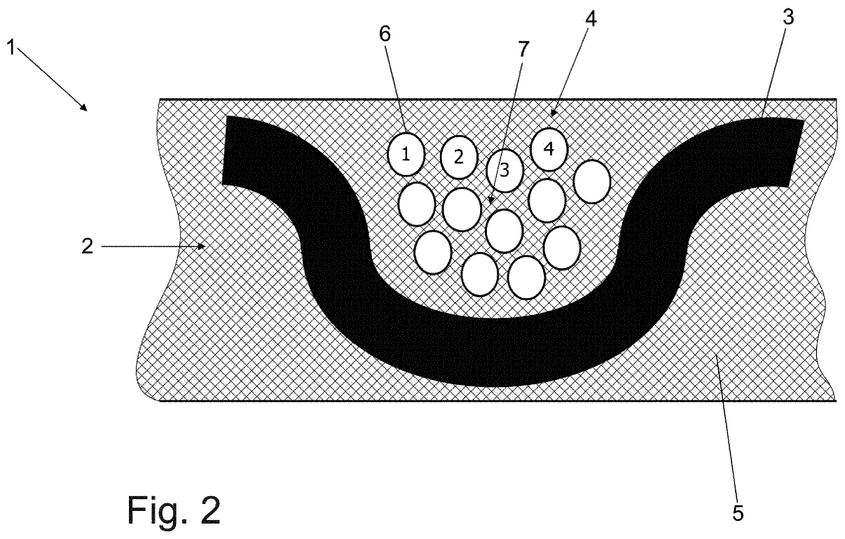

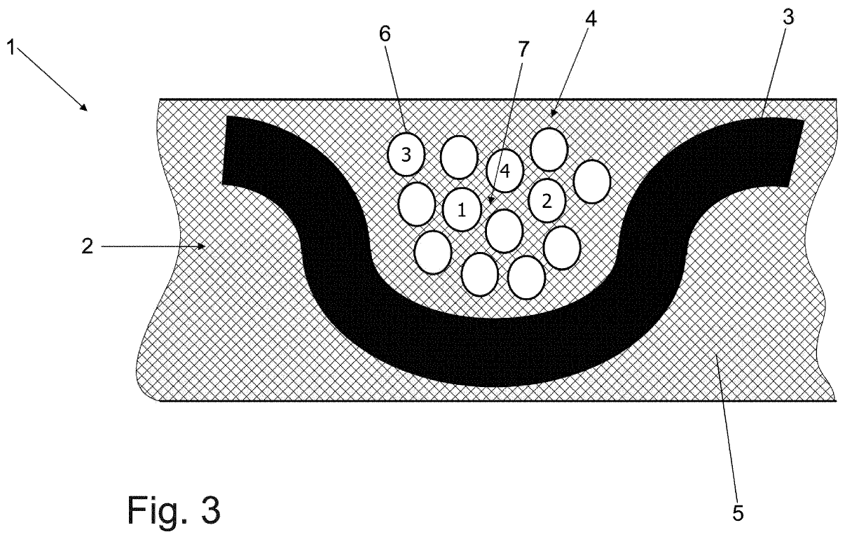

At least one of the connection elements 4 described is provided as a multifilament or is formed as a multifilament. In particular, all of the connection elements 4 are formed as multifilaments. FIGS. 2 and 3 show a state of the air gap can 1 in which the structural layer 2 with the structural elements 3 and connection elements 4 is impregnated with the matrix material 5. For example, the state shown in FIGS. 2 and 3 can depict a cured state.

FIGS. 2 and 3 show, for example, a detail view along a connection element 4 in the structural layer 2, i.e., the longitudinal axis of the connection element 4 in FIGS. 2 and 3 extends into/out of the drawing plane. It can be seen that the connection element 4 is embodied as a multifilament, i.e., the connection element 4 has a plurality of individual fibrous elements 6.

Purely by way of example, four of the individual fibrous elements 6 in FIGS. 2 and 3 are designated by numbers, and it can be seen that the individual fibrous elements 6 change their positions in the cross sections shown in FIG. 2 which shows, for example, a first axial position and in FIG. 3 which shows, for example, a second axial position. It follows that the individual fibrous elements 6 do not run exclusively parallel along the longitudinal direction of the connection element 4, but can change their radial position, for example, relative to a center point or the center axis or longitudinal axis of the connection element 4.

In particular, the individual fibrous elements 6 are intertwined or tangled or twisted with one another. The individual fibrous elements 6 can be arranged as a defined intertwining or a randomly arranged tangled structure. Advantageously, owing first of all to the appreciably smaller diameter of the individual fibrous elements 6 compared to an individual monofilament, there is significantly less weakening of the connection between the matrix material 5 and connection element 4, and even in the event that a crack or channel forms, it is limited to the respective individual fibrous element 6, resulting in a crack-stopping effect which is particularly reinforced by the intertwining or entangling with the other individual fibrous elements 6.

Further, providing the connection element 4 as a multifilament results in an advantage in that receiving spaces 7 are formed between the individual fibrous elements 6 into which the matrix material 5 penetrates during impregnation. Compared to a multifilament with an appreciably larger diameter corresponding, for example, to the diameter of the total cross section of the connection element 4, an appreciably larger connection between the matrix material 5 and the connection element 4 is achieved. In other words, the individual fibrous elements 6 are individually surrounded, respectively, by matrix material 5 so that the contact area between matrix material 5 and connection element 4 is appreciably increased compared to a monofilament which only contacts the matrix material 5 at its outer circumference.

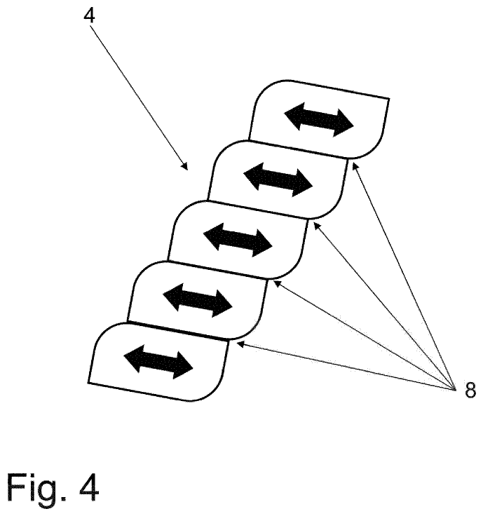

FIG. 4 shows a schematic representation of a connection element 4. The connection element 4 shown purely by way of example in FIG. 4 is twisted about its longitudinal axis so that the individual fibrous elements 6 shown, for example, in FIGS. 2 and 3 are twisted in circumferential direction relative to the longitudinal direction or longitudinal axis of the connection element 4. For example, the individual fibrous elements 6 form a helix around the longitudinal axis of the connection element 4. This results in the formation of undercuts 8 or constrictions, for example, in the manner of a braid, into which matrix material 5 can penetrate, and the connection between the matrix material 5 and the connection element 4 can be improved appreciably in this way compared to a substantially cylindrical configuration of a monofilament. In other words, a positive engagement is formed between the matrix material 5 and the connection element 4 by the undercuts 8, which further facilitates a surrounding and positioning of the connection element 4 within the structural layer 2.

The air gap can 1 shown can be produced in particular as a component of an assembly for an electric machine, particularly an electric machine of a motor vehicle. For this purpose, as described above, the at least one structural layer 2 can be applied to a core and impregnated with the matrix material 5. The matrix material 5 can be cured subsequently to form the air gap can 1. The air gap can may then be removed from the core and inserted into an opening in the base body of a stator. In the assembled state in the base body opening, the air gap can 1 separates the stator space from the rotor space in the electric machine in a manner known per se so that liquid, for example, coolant, cannot penetrate into the stator space from the rotor space, or vice versa.

The preceding description of the method for producing the air gap can 1 is therefore fully transferable to the air gap can 1, the electric machine, and the motor vehicle. In principle, the advantages, details and features shown in the individual figures can be combined with one another as desired, are interchangeable and are transferable to one another.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-10. (Canceled)

11. A method for producing an air gap can for an electric machine, which air gap can is arrangeable or is arranged in a base body opening of a stator base body of the electric machine, wherein the air gap can, when mounted in the base body opening, is formed to separate a stator space and a rotor space of the electric machine, comprising:
at least one structural layer comprising a plurality of structural elements, the plurality of structural elements of which are connected to at least one connection element;
arranging the at least one structural layer on a core;
impregnating the at least one structural layer on the core with a matrix material;
curing the matrix material; and
connecting at least two structural elements of at least one structural layer with a connection element formed as a multifilament.

12. The method according to claim 11, wherein a total cross section of the at least one connection element is formed from individual cross sections of individual fibrous elements forming the connection element.

13. The method according to claim 12, wherein receiving spaces for the matrix material are formed between the individual fibrous elements of the at least one connection element.

14. The method according to claim 11,
wherein the at least one connection element defines a longitudinal direction,
wherein at least one individual fibrous element are arranged at least partially in an orientation deviating from the longitudinal direction.

15. The method according to claim 11,
wherein the at least one connection element is connected to the at least two structural elements by a defined type of weave,
wherein a crack occurring in the matrix material along at least one individual fibrous element can be stopped by the type of weave.

16. The method according to claim 15, wherein the at least one connection element is connected to the at least two structural elements by a chain weave or a tricot weave.

17. The method according to claim 12, wherein individual fibrous elements of the at least one connection element are twisted in circumferential direction.

18. An air gap can for an electric machine, comprising:
a base body opening of a stator base body of the electric machine in which the air gap can is arrangeable or is arranged;
wherein, in a state in which it is mounted in the base body opening, the air gap can is formed to separate a stator space and a rotor space of the electric machine,
wherein the air gap can has at least one structural layer comprising a plurality of structural elements, configured as a layup or a woven fabric, the structural elements of which are connected to at least one connection element, configured as a sewing thread, wherein the at least one structural layer is impregnated with a matrix material and cured, and
wherein at least two structural elements of at least one structural layer are connected to a connection element formed as a multifilament.

19. An electric machine comprising:
an air gap can, comprising:
a base body opening of a stator base body of the electric machine in which the air gap can is arrangeable or is arranged;
wherein, in a state in which it is mounted in the base body opening, the air gap can is formed to separate a stator space and a rotor space of the electric machine,
wherein the air gap can has at least one structural layer comprising a plurality of structural elements, configured as a layup or a woven fabric, the structural elements of which are connected to at least one connection element, configured as a sewing thread, wherein the at least one structural layer is impregnated with a matrix material and cured, and
wherein at least two structural elements of at least one structural layer are connected to a connection element formed as a multifilament.

20. A motor vehicle comprising:
an electric machine comprising:
an air gap can, comprising:
a base body opening of a stator base body of the electric machine in which the air gap can is arrangeable or is arranged;
wherein, in a state in which it is mounted in the base body opening, the air gap can is formed to separate a stator space and a rotor space of the electric machine,
wherein the air gap can has at least one structural layer comprising a plurality of structural elements, configured as a layup or a woven fabric, the structural elements of which are connected to at least one connection element, configured as a sewing thread, wherein the at least one structural layer is impregnated with a matrix material and cured, and
wherein at least two structural elements of at least one structural layer are connected to a connection element formed as a multifilament.

21. The method according to claim 11, wherein the at least one structural layer is a layup or a woven fabric.

22. The method according to claim 11, wherein the at least one connection element, is a sewing thread.

23. The method according to claim 14, wherein all of the individual fibrous elements are arranged at least partially in the orientation deviating from the longitudinal direction.
